(19) United States
(12) Patent Application Publication
(10) Pub. No.: US 2026/0060472 A1
(43) Pub. Date: Mar. 5, 2026

(54) SYSTEMS AND METHODS FOR FOOD HOLDING

(71) Applicant: CFA Properties, Inc., Atlanta, GA (US)

(72) Inventors: Andy Wu, Mableton, GA (US); Ashley Russell, Duluth, GA (US)

(21) Appl. No.: 19/316,616

(22) Filed: Sep. 2, 2025

Related U.S. Application Data
(60) Provisional application No. 63/689,145, filed on Aug. 30, 2024.

(51) Int. Cl. A47J 36/26

(52) U.S. Cl. CPC A47J 36/26

(57) ABSTRACT

Embodiments of the present disclosure relate to a system and method for holding and warming food products. An example system includes a bottom surface and a food pan positioned on the bottom surface and comprising a plurality of food products. The system may further include a first lip extending over a first side of the food pan. The system may further include a second lip extending over a second side of the food pan. The first lip and the second lip may be spaced apart from one another to define a gap providing access to the plurality of food products. The first lip and the second lip may each comprise an airflow mechanism configured to direct a heated airflow through the plurality of food products.

### CROSS-REFERENCE TO RELATED APPLICATIONS

This application claims the benefit of and priority to U.S. Application No. 63/689,145 filed Aug. 30, 2024, entitled “FOOD WARMER,” the disclosure of which is hereby comprised by reference in its entirety.

### TECHNICAL FIELD

This application generally relates to systems and processes for maintaining food products within a temperature range.

### BACKGROUND

In quick service restaurant (QSR) operations, maintaining prepared food products at proper serving temperatures presents ongoing challenges for operators seeking to balance food quality and operational efficiency. Food products that have been cooked through various methods, such as frying, grilling, or baking, typically reach peak quality immediately after cooking but may deteriorate in texture, flavor, and visual appeal as they cool toward ambient temperature. Therefore, there exists a desire to preserve food quality through one or more food warming techniques by which the temperature of the food product is temporarily held and maintained within a target temperature range.

Existing food holding and warming approaches in QSR kitchens typically rely on overhead heat lamps or heated holding cabinets. Heat lamps may create uneven temperature distribution, with food surfaces directly exposed to the lamps becoming overheated while other areas remain cooler. This uneven heating can lead to degradation of food texture, such as dried-out surfaces, loss of moisture, sogginess, and/or the like. Additionally, heat lamps consume considerable energy and generate substantial heat in kitchen environments, contributing to uncomfortable working conditions and increased cooling costs. Further, heat lamps may generate excessive temperatures that pose a potential harm to team members. For example, metallic surfaces may be excessively warmed by heat lamps, presenting a risk of heat injury when contacted by team members.

Heated holding cabinets, while providing more controlled environments, often occupy substantial floor space and may not provide adequate air circulation around individual food products. The bulky nature of these cabinets may be particularly problematic in space-constrained QSR kitchen environments where square footage is limited and workflow efficiency depends on compact, accessible equipment arrangements. Many conventional warming systems also lack the operational efficiency needed for rapid food retrieval during peak service periods, as accessing individual food products from deep cabinet compartments may require team members to open doors, reach into confined spaces, and navigate around other stored products, creating time delays that may impact customer service speed and kitchen workflow.

For these reasons, among others, existing approaches have not yet solved the challenges of achieving uniform temperature distribution throughout food holding areas while maintaining energy efficiency and operational convenience.

### SUMMARY

Embodiments of the present disclosure relate to apparatuses, devices, systems, and methods for warming food products. An example system for warming products may include a bottom surface configured to receive a food container comprising a plurality of food products. The food holding system may further include a first sidewall extending upward from a first edge of the bottom surface and comprising a first lip extending over at least a first portion of the bottom surface. The food holding system may further include a second sidewall extending upward from a second edge of the bottom surface and comprising a second lip extending over at least a second portion of the bottom surface. The first lip and the second lip may define a gap between one another. The gap may be configured to provide access to the plurality of food products within the food container. The first lip may comprise a first airflow mechanism configured to direct a first heated airflow directed into the food container. The second lip may comprise a second airflow mechanism configured to direct a second heated airflow directed into the food container. The first heated airflow and the second heated airflow may be configured to maintain the plurality of food products within a predetermined temperature range.

In some embodiments, the food holding system further comprises a void extending between the first sidewall and the second sidewall. In some embodiments, the void enables bidirectional insertion of the food container into the food holding system. In some embodiments, the first airflow mechanism and the second airflow mechanism comprise, respectively, a plurality of nozzles extending along at least a subset of the first lip or the second lip. In some embodiments, the plurality of nozzles comprises at least one row of nozzles.

In some embodiments, the first airflow mechanism and the second airflow mechanism comprise, respectively, a slot extending along at least a portion of the first lip or the second lip. In some embodiments, the food container comprises a food pan. In some embodiments, the food pan comprises: a bottom surface; a food holder configured to support the plurality of food products; and an offset between the food holder and the bottom surface, the offset configured to allow the first heated airflow and the second heated airflow to circulate beneath the plurality of food products. In some embodiments, the food holder embodies a wire trivet. In some embodiments, the food holding system embodies a wire basket. In some embodiments, the wire basket comprises a plurality of sidewalls. In some embodiments, at least a subset of the plurality of sidewalls are offset relative to corresponding sidewalls of the food container.

In some embodiments, the food holding system is unenclosed. In some embodiments, the food holding system further comprises at least one blower positioned inferior to the bottom surface and configured to provide the first heated airflow to the first airflow mechanism and the second heated airflow to the second airflow mechanism. In some embodiments, the first heated airflow and the second heated airflow are configured to create a circulation pattern comprising a downward flow along interior surfaces of the food container and an upward return flow through spaces between the plurality of food products. In some embodiments, at least one of the bottom surface, the first sidewall, or the second sidewall comprises at least one heating mechanism configured to generate at least one the first heated airflow or the second heated airflow.

In another example, a food holding system may comprise a bottom surface; a food pan positioned on the bottom surface and comprising a plurality of food products; a first lip extending over a first side of the food pan; a second lip extending over a second side of the food pan; the first lip and the second lip spaced apart from one another to define a gap providing access to the plurality of food products; and the first lip and the second lip each comprising an airflow mechanism configured to direct a heated airflow through the plurality of food products.

In some embodiments, the food holding system further comprises at least one humidity control mechanism configured to control a respective moisture level of the heated airflow. In some embodiments, the food holding system further comprises at least one air intake within at least one of the first lip or the second lip. In some embodiments, the at least one air intake is configured to receive the heated airflow for recirculation through the airflow mechanism.

In some embodiments, the food holding system further comprises at least one heating element positioned inferior to the bottom surface and configured to provide heated air to the airflow mechanism. In some embodiments, a length of the bottom surface is equal to a length of the food pan. In some embodiments, the food holding system further comprises at least one blower configured to generate the heated airflow, wherein the at least one blower is positioned inferior to the bottom surface.

An example method of holding warmed food products may include receiving a food container onto a bottom surface of a food holding system to position a first side of the food container under a first lip of the food holding system and a second side of the food container under a second lip of the food holding system. The method may further include exposing a plurality of food products for retrieval from the food container through a gap between the first lip and the second lip. The method may further include directing, via an airflow mechanism of the first lip, a first heated airflow into the first side of the food container. The method may further include directing, via an airflow mechanism of the second lip, a second heated airflow into the second side of the food container. The food container may comprise a plurality of food products held at an offset above a bottom surface of the food container.

### BRIEF DESCRIPTION OF FIGURES

Having thus described the embodiments of the disclosure in general terms, reference now will be made to the accompanying drawings, which are not necessarily drawn to scale, and wherein:

FIG. 1 shows a perspective view of an example food holding system and food container in accordance with some embodiments of the present disclosure;

FIG. 2 shows a perspective view of an example food holding system and food container in accordance with some embodiments of the present disclosure;

FIG. 3 shows a perspective view of an example food holding system and food container in accordance with some embodiments of the present disclosure;

FIG. 4 shows a cross section of an example food holding system and food container in accordance with some embodiments of the present disclosure; and

FIG. 5 show a cross section of an example food holding system, food container, and food holder in accordance with some embodiments of the present disclosure.

### DETAILED DESCRIPTION

In general, various embodiments of the present disclosure provide improved systems for holding food products and maintaining the held food products within a target temperature range. For purposes of describing and illustrating exemplary aspects of the systems, the proceeding description is presented in the context of holding fried food products, such as tenders, fillets, nuggets, and/or the like. Within such context, the system is interchangeably referred to herein as a “food holding system.” It will be understood and appreciated that such context is provided by way of example and uses of the system in additional contexts, such as with grilled food products, are contemplated and within the scope of the invention.

Historical approaches to maintaining prepared food products at serving temperatures in QSR environments encounter challenges in meeting the efficiency, food quality, and operational goals of QSRs. For example, food products positioned directly beneath heat lamps may experience surface overheating and moisture loss, while items at the periphery of the heating zone may cool toward ambient temperature, concentrate or retain excess moisture (e.g., becoming soggy), and/or the like. Consequently, food quality may deteriorate through dried-out surfaces, texture degradation, inconsistent serving temperatures, sogginess, and/or the like, that impact customer satisfaction. The substantial heat of overhead heat lamps may also impose significant energy costs, contribute to uncomfortable working conditions, and create safety hazards when metallic surfaces become excessively heated.

As another example, heated holding cabinets, heating lamp systems, and/or the like, may occupy valuable floor space in constrained kitchen environments while limiting accessibility to individual food products during peak service periods. The bulky nature of cabinet systems may require team members to open doors, reach into confined spaces, and navigate around stored products, creating time delays that impact service speed and workflow efficiency. Additionally, existing systems typically include substantial dimensions that far exceed the dimensions of the food containers held within, which results in spatial inefficiency and limited scalability.

To overcome these challenges, and others, the present disclosure provides an improved food holding system that maintains uniform temperature distribution throughout food storage areas at least in part by directing controlled heated airflow through strategic circulation patterns. In various embodiments, the system includes an open-access configuration comprising one or more airflow mechanisms positioned above a food container to create balanced thermal conditions without requiring enclosed cabinet structures. As used herein, “unenclosed” is intended to cover configurations that provide direct access to food products without doors or complete enclosure elements while maintaining controlled heating environments.

In various embodiments, the food holding system more effectively maintains food product temperatures as compared to conventional heat lamp or cabinet-based systems commonly used in QSRs. As another example, the food holding system may demonstrate greater energy efficiency due at least in part to the targeted delivery of heated airflow directly to food storage areas and recirculation capabilities that minimize heat loss to ambient environments. In still another example, the food holding system may increase operational efficiency by enabling rapid access to individual food products through an open gap configuration while maintaining consistent temperature control through symmetrical airflow distribution. The open-access configuration may enable team members to efficiently reach directly into the food container through the gap between the opposing airflow mechanisms, allowing for rapid retrieval of individual food products without obstruction from doors or overhead structures. For example, a team member may position a gloved hand, serving tongs or other utensils through the gap to access food products positioned anywhere within the food container while the airflow mechanisms continue to maintain temperature control around the remaining items. In various embodiments, the food holding system accommodates food products that may be stacked in random orientations and configurations without requiring separation or organized arrangement within the food container. For example, even when food products are positioned in overlapping or irregular arrangements, the heated airflows and circulation patterns may provide uniform temperature distribution that maintains consistent heating throughout the food mass without requiring specialized tier baskets or manual separation procedures that may slow food service operations. These advantages, and others, shall be made further apparent in the proceeding description of example embodiments of the food holding system and the illustrations thereof provided in the accompanying figures.

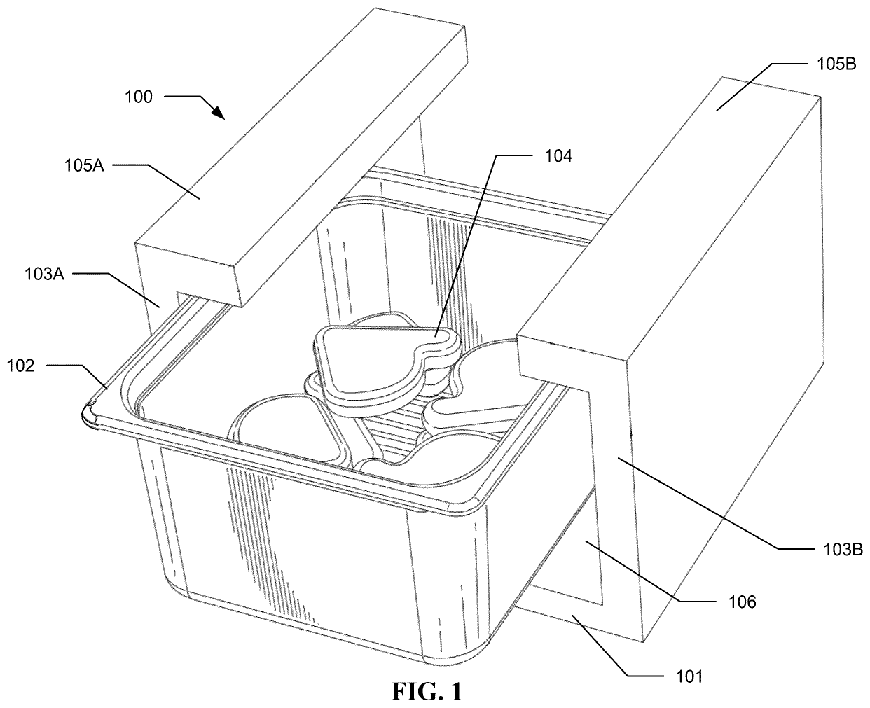

Referring to FIG. 1, shown is a perspective view of a food holding system 100 and a food container 102. In various embodiments, the food holding system 100 provides a structural framework configured to maintain cooked food products at optimal serving temperatures through controlled airflow distribution. In some embodiments, the food holding system 100 comprises a bottom surface 101 that receives a food container 102 containing a plurality of food products 104. In various embodiments, the bottom surface 101 extends horizontally to provide stable positioning for the food container 102 while facilitating thermal management operations. For example, the bottom surface 101 may define a planar receiving area that accommodates standardized food container dimensions commonly used in commercial food service applications. In various embodiments, the length of the bottom surface 101 is substantially equal to the length of the food container 102, which may support spatial efficiency and a minimal footprint in the QSR kitchen environment. In some embodiments, the food container 102 embodies a food pan. Alternatively, in some embodiments, the food container 102 embodies a wireframe basket.

In some embodiments, a first sidewall 103A extends vertically upward from a first edge of the bottom surface 101, establishing a structural boundary that defines one side of the food holding system 100. In various embodiments, the first sidewall 103A provides vertical support and houses components for airflow generation and distribution. For example, the first sidewall 103A may comprise one or more internal channels or passages that facilitate the movement of heated air from heating mechanisms to distribution points positioned above the food container 102. In some embodiments, a second sidewall 103B extends vertically upward from a second edge of the bottom surface 101, positioned opposite to the first sidewall 103A to create a symmetrical configuration. In various embodiments, the second sidewall 103B mirrors the structural and functional characteristics of the first sidewall 103A, providing balanced airflow distribution capabilities across the food holding system 100.

In some embodiments, the first sidewall 103A comprises a first lip 105A that extends horizontally from the top portion of the first sidewall 103A, positioning the first lip 105A over one or more first portions of the bottom surface 101. In various embodiments, the first lip 105A serves as a mounting platform for airflow mechanisms while providing a partial overhead coverage area above the food container 102. For example, the first lip 105A may extend horizontally toward the second sidewall 103B for a predetermined distance that optimizes airflow distribution patterns while maintaining accessibility to the food products 104. In some embodiments, the second sidewall 103B comprises a second lip 105B that extends horizontally from the top portion of the second sidewall 103B toward the first lip 105A, positioning the second lip 105B over one or more second portions of the bottom surface 101. In various embodiments, the second lip 105B operates in conjunction with the first lip 105A to create a coordinated airflow system that promotes uniform temperature distribution throughout the food container 102.

As shown in FIG. 1, the first lip 105A and the second lip 105B define a gap between one another, creating an open access area above the food container 102. In some embodiments, the gap provides unobstructed access to the plurality of food products 104 within the food container 102, enabling food service personnel to retrieve individual items without interference from overhead structures. In various embodiments, the gap dimensions are calibrated to balance accessibility requirements with thermal efficiency considerations, ensuring that heated airflow distribution remains effective while maintaining operational convenience. For example, the gap may span a distance that accommodates standard serving utensils and/or gloved hands and allows visual inspection of food products 104 while preventing excessive heat loss from the food holding system 100.

In some embodiments, a void 106 extends between the first sidewall 103A and the second sidewall 103B, providing an open space that enables bidirectional insertion of the food container 102 into the food holding system 100. In various embodiments, the void 106 facilitates operational flexibility by allowing the food container 102 to be inserted from either end of the food holding system 100, promoting symmetrical heating patterns and reducing the likelihood of temperature variations across different areas of the food products 104. As another example, the bidirectional insertion capability may enable food service operations to position multiple food holding systems 100 in series while maintaining efficient workflow patterns and minimizing handling time for food container 102 placement and removal.

In various embodiments, the food holding system 100 provides an unenclosed configuration, which overcomes challenges of conventional enclosed holding and warming systems. For example, the open cabinet design eliminates doors or complete enclosure elements, enabling team members to quickly and readily access food products. As another example, the unenclosed design may promote uniform air circulation patterns that complement the controlled airflow distribution while preventing moisture accumulation or overheating that may affect food product quality. In this manner, the open configuration may facilitate rapid access to food products 104 during peak service periods while maintaining consistent temperature control through strategic airflow positioning.

In various embodiments, the food container 102 is a receptacle configured to hold the plurality of food products 104. In some embodiments, the food container 102 comprises structural features that promote airflow circulation beneath and around the food products 104, enhancing heat transfer efficiency throughout the container volume. In various embodiments the food container 102 includes a food holder comprising one or more voids that enable air to flow through the container to more completely and uniformly contact food products 104. For example, the food holder may embody or include a trivet, and/or the like, that provides an offset between the food products 104 and the bottom of the food container 102, enabling airflows to penetrate under and circulate beneath the food products 104.

In some embodiments, the food holder embodies or includes a wire basket comprising a bottom surface and sidewalls penetrable to air. The bottom surface of the wire basket may be vertically offset from a bottom interior surface of the food container 102. In some embodiments, one or more sidewalls of the wire basket may be offset from a corresponding sidewall of the food container 102, forming a void space extending downward along the height of the wire basket. In this manner, heated airflows may pass directly downward between the sidewall of the wire basket and the sidewall of the food container 102 (e.g., into the void space defined by the vertical offset between the bottom surface of the wire basket and the bottom interior surface of the food container 102). The pass-through configuration of the sidewalls may enhance thermal circulation by enabling heated airflow to reach all surfaces of the food products 104 while preventing stagnation zones that, in existing approaches, may arise on the bottom surfaces of food products. For example, the circulation pattern created by the food holding system 100 may provide thermal advantages by directing heated airflow to contact the food products 104 at their bottom surfaces, which may be particularly beneficial for maintaining uniform temperature distribution. In some embodiments, this approach addresses limitations commonly encountered with conventional heat lamp systems, where food products positioned at lower levels within containers may receive insufficient thermal exposure due to shadowing effects or distance from overhead heat sources. For example, food products 104 positioned at the bottom of stacked arrangements may experience inadequate warming when relying solely on radiant heat from above, potentially creating temperature gradients that affect food quality and safety compliance.

In some embodiments, the heated airflow circulation pattern takes advantage of natural convective principles by initiating thermal contact at the bottom surfaces of the food products 104, where warm air may then rise naturally through the food container 102 volume. In various embodiments, the bottom-up heating approach may leverage tendency of heated air to rise in ambient conditions, creating sustained circulation currents that promote comprehensive thermal exposure throughout the food products 104. For example, as heated air contacts the bottom surfaces of the food products 104 and absorbs additional thermal energy, the warmed air may continue to rise through spaces between individual food items, carrying heat to upper portions of the food container 102 that may otherwise remain cooler in conventional heating systems.

In various embodiments, the bottom-initiated heating pattern may provide more consistent temperature maintenance across food products 104 of varying sizes and densities by ensuring that thermal energy reaches all items regardless of their vertical positioning within the food container 102. In some embodiments, this approach may be particularly advantageous for dense or heavily breaded food products that require sustained heat penetration to maintain internal temperatures, as the rising heated air may provide continuous thermal input as the airflow moves upward through the food mass. As another example, the bottom-first heating approach may reduce the likelihood of surface overheating that can occur with direct overhead radiant heating, while ensuring that lower portions of food products 104 receive adequate thermal treatment to maintain serving temperature requirements.

In some embodiments, the plurality of food products 104 represents various cooked food products that require temperature maintenance prior to serving, including fried chicken, breaded items, and other prepared foods that benefit from controlled warming environments.

In various embodiments, the symmetrical configuration of the first sidewall 103A and second sidewall 103B, along with the corresponding first lip 105A and second lip 105B, support balanced thermal conditions and airflow circulation that promote uniform heating regardless of the food container 102 insertion direction. In some embodiments, the symmetrical configuration eliminates preferential heating zones that may result in uneven food product temperatures or quality variations. As another example, the symmetrical airflow distribution may compensate for natural heat loss patterns that occur at container edges or corners, ensuring that food products 104 positioned throughout the food container 102 receive consistent thermal treatment. For example, the balanced configuration may enable the food holding system 100 to maintain temperature uniformity even when the food container 102 is only partially filled or as food products 104 are removed or added during service operations.

In some embodiments, the structural configuration of the food holding system 100 accommodates one or more elements that enable dynamic adjustment of air velocity and volume parameters based on operational requirements. In various embodiments, the first sidewall 103A and second sidewall 103B provide mounting locations for sensors, control mechanisms, or additional airflow components that support advanced temperature management capabilities. For example, the system architecture may include weight sensors, product volume sensors, and/or the like, that may be used to trigger increased or decreased airflow rates for extended hold times or higher food product volumes without requiring structural changes to the bottom surface 101, sidewalls, or lip configurations. As another example, the modular design approach may enable retrofitting of existing food holding systems 100 with enhanced control capabilities while maintaining compatibility with standard food container 102 dimensions and operational procedures.

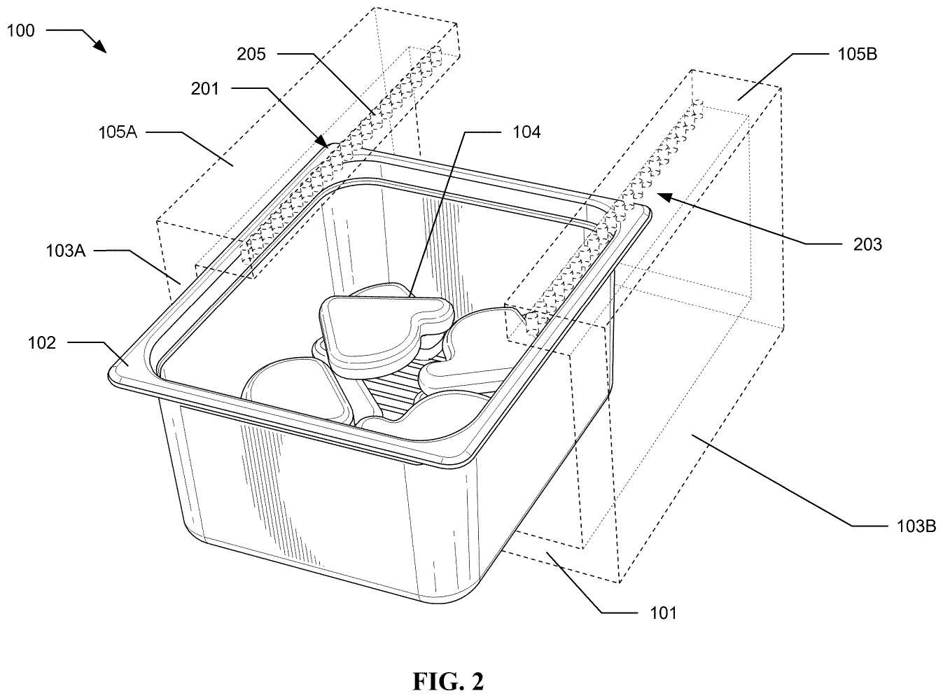

Referring to FIG. 2, shown is another perspective view of the food holding system 100. For purposes of illustrating and describing elements of the food holding system 100, portions of the sidewalls 103A, 103B and lips 105A, 105B are depicted as transparent. In some embodiments, the first lip 105A comprises one or more first airflow mechanisms 201 configured to direct a heated airflow downward toward a first subset of the bottom surface 101. In doing so, the first lip 105A may direct heated airflows into a first side of the food container 102. In various embodiments, the first airflow mechanism 201 provides a dedicated pathway for directing controlled heated airflow downward into the food container 102. In various embodiments, the first airflow mechanism 201 comprises internal channels, ducting, distribution networks, and/or the like that facilitate uniform air delivery across the length of the first lip 105A, or a subset thereof. For example, the first airflow mechanism 201 may include manifold structures that distribute heated air from a central supply source to multiple discharge points positioned along the first lip 105A. As another example, the first airflow mechanism 201 may comprise flow regulation components that enable precise control of air velocity and temperature parameters based on operational requirements.

In various embodiments, the second lip 105B comprises one or more second airflow mechanisms 203, which may be in a configuration that mirrors the functionality of the first airflow mechanism 201. For example, the second airflow mechanism 203 may be configured to direct a heated airflow downward toward a second subset of the bottom surface 101. In doing so, the first lip 105A may direct heated airflows into a second side of the food container 102. The first airflow mechanism 201 and second airflow mechanism 203 may be arranged opposite and spaced apart from one another, providing a balanced airflow distribution arrangement across the food holding system 100. In various embodiments, the second airflow mechanism 203 operates in coordination with the first airflow mechanism 201 to establish circulation patterns that promote uniform temperature distribution throughout the food container 102. For example, the second airflow mechanism 203 may comprise identical internal components and flow characteristics as the first airflow mechanism 201 to maintain symmetrical heating conditions. As another example, the second airflow mechanism 203 may include independent control capabilities that enable differential airflow adjustments based on temperature measurements or food product positioning within the food container 102. In some embodiments, the food holding system 100 comprises one airflow mechanism. For example, the food holding system 100 may comprise an airflow mechanism 201 or an airflow mechanism 203, which may reduce energy consumption of the food holding system 100 while maintaining consistent thermoregulation performance.

As shown in FIG. 2, a nozzle 205 represents one of multiple air discharge points that may direct heated airflow from the first airflow mechanism 201 and/or the second airflow mechanism 203 into the food container 102. For example, the first airflow mechanism 201, second airflow mechanism 203, and/or the like may include a row of nozzles 205 extending along the length of the mechanism, or a subset thereof. In various embodiments, the nozzle 205 is angled vertically downward toward the bottom surface 101. In some embodiments, the nozzle 205 comprises angular adjustment capabilities that enable optimization of airflow direction based on temperature discrepancy measurements from top to bottom of the food container 102. For example, the nozzle 205 may be repositionable, enabling adjustments to the air circulation profile. In some embodiments, the nozzle 205 angle adjustment feature responds to thermal monitoring data that indicates temperature variations within the food container 102, with more heating applied when the top portion registers cooler temperatures than the bottom portion. For example, the nozzle 205 may comprise mechanical adjustment mechanisms that enable repositioning to direct airflow toward specific areas of the food container 102 that require additional thermal input.

In some embodiments, the first airflow mechanism 201 and the second airflow mechanism 203 comprise a row of nozzles extending along at least a portion of the first lip 105A or the second lip 105B, providing multiple discharge points that distribute heated airflow along the length of the food container 102. In various embodiments, the row of nozzles includes a first set of nozzles configured to output heated airflow in a first angular direction and a second set of nozzles configured to generate airflow in a second angular direction. For example, the first set of nozzles may direct airflow at a steeper downward angle to penetrate deeper into the food container 102, while the second set of nozzles may direct airflow at a shallower angle to promote surface heating of the food products 104. As another example, the angular differentiation between nozzle sets may create overlapping airflow patterns that eliminate cold spots and ensure comprehensive thermal coverage throughout the food container 102 volume.

Alternatively, or additionally, in some embodiments, the first airflow mechanism 201, the second airflow mechanism 203, and/or the like comprise one or more slots that extend along at least a subset of the first lip 105A or the second lip 105B. The slot may be configured to direct a heated airflow downward into the food container 102. In some embodiments, the slot configuration provides continuous airflow distribution, such as by generating air curtains that blanket the food container 102 with heated air. In various embodiments, the slot includes internal baffles or flow directors that ensure uniform air distribution along the slot length, accommodating for variations in supply pressure or temperature. As another example, the slot may include adjustable aperture controls that enable modification of discharge characteristics without requiring individual nozzle adjustments.

In some embodiments, the first lip 105A, second lip 105B, and/or other portions of the structure, such as the sidewalls 103A, B comprise one or more air circulation intakes configured to facilitate recirculation of heated airflow. In some embodiments, the air circulation intakes comprise or are connected to one or more moisture control mechanisms configured to provide moisture scrubbing capabilities that remove accumulated humidity from the recirculated air. In various embodiments, the air circulation intakes capture heated air that has circulated through the food container 102 and direct the air back to heating elements for temperature restoration, moisture removal processing, and/or the like. For example, the air circulation intakes may comprise filtration or condensation removal systems that extract moisture content before returning the air to the first airflow mechanism 201 or the second airflow mechanism 203. As another example, the humidity control mechanism may extend hold time for the food products 104 by preventing humidity accumulation that may affect food quality or texture characteristics. The humidity control mechanism may also or alternatively comprise a humidifier that adds humidity to the airflow to prevent food products from drying out and becoming less desirable.

In various embodiments, the food holding system 100 comprises one or more heating elements configured to provide heated air to the first airflow mechanism 201 and the second airflow mechanism 203. For example, the heating element may heat air, which may be passed to the airflow mechanisms 201, 203 through supply conduits. In some embodiments, the heating element is positioned inferior to the bottom surface 101. In some embodiments, the inferior positioning of heating elements provides space efficiency advantages by locating heat generation components below the food holding system 100 structure rather than within the sidewall assemblies or above the first lip 105A and second lip 105B. For example, the heating elements may comprise fan assemblies that generate both heated air and the pressure differential required to drive airflow through the first airflow mechanism 201 and the second airflow mechanism 203. As another example, the inferior positioning may enable multiple food holding systems 100 to share common heating infrastructure while maintaining independent airflow control for each system. The heating elements may, according to embodiments, be positioned within the illustrated bottom surface structure and/or sidewalls 103 A, B space permitting.

In some embodiments, the food holding system 100 comprises one or more blowers configured to provide the first heated airflow to the first airflow mechanism 201 and the second heated airflow to the second airflow mechanism 203. For example, the blower may direct the respective airflows through dedicated supply networks that maintain independent control of each airflow system. In some embodiments, the blower is positioned inferior to the bottom surface 101. In various embodiments, the blower comprises variable speed capabilities that enable dynamic adjustment of airflow rates based on operational requirements or thermal monitoring feedback. For example, the blower may increase airflow velocity and volume to compensate for longer hold times or higher food product volumes within the food container 102. As another example, the blower may comprise differential control capabilities that enable independent adjustment of the first heated airflow and the second heated airflow to address asymmetrical heating requirements or food product positioning variations.

As further shown in FIG. 2, the integration of the first airflow mechanism 201 and the second airflow mechanism 203 with the nozzle 205 may provide air circulation patterns that direct heated airflow downward along interior surfaces of the food container 102 before returning upward through spaces beneath and/or between the food products 104. In some embodiments, the circulation pattern promotes comprehensive thermal exposure for all food products 104 regardless of positioning within the food container 102. In various embodiments, the downward flow component ensures that heated air reaches the bottom portions of the food container 102, while the upward return flow carries thermal energy through the food product mass to maintain uniform temperature distribution. For example, the circulation pattern may create convective currents that continuously move heated air around individual food products 104 to prevent thermal stratification or localized cooling. As another example, the bidirectional airflow characteristics may compensate for natural heat loss patterns that occur at container edges or exposed surfaces.

In some embodiments, the nozzle 205 and associated discharge points comprise directional control features that enable optimization of airflow patterns based on the specific characteristics of the food products 104 or the food container 102 configuration. In various embodiments, the directional control capabilities respond to feedback from temperature monitoring systems that detect thermal variations within the food container 102 and automatically adjust nozzle angles or airflow distribution patterns to address identified deficiencies. For example, the directional control system may detect that the top portion of the food container 102 registers lower temperatures than the bottom portion and respond by adjusting nozzle angles to direct additional heated airflow toward the cooler areas.

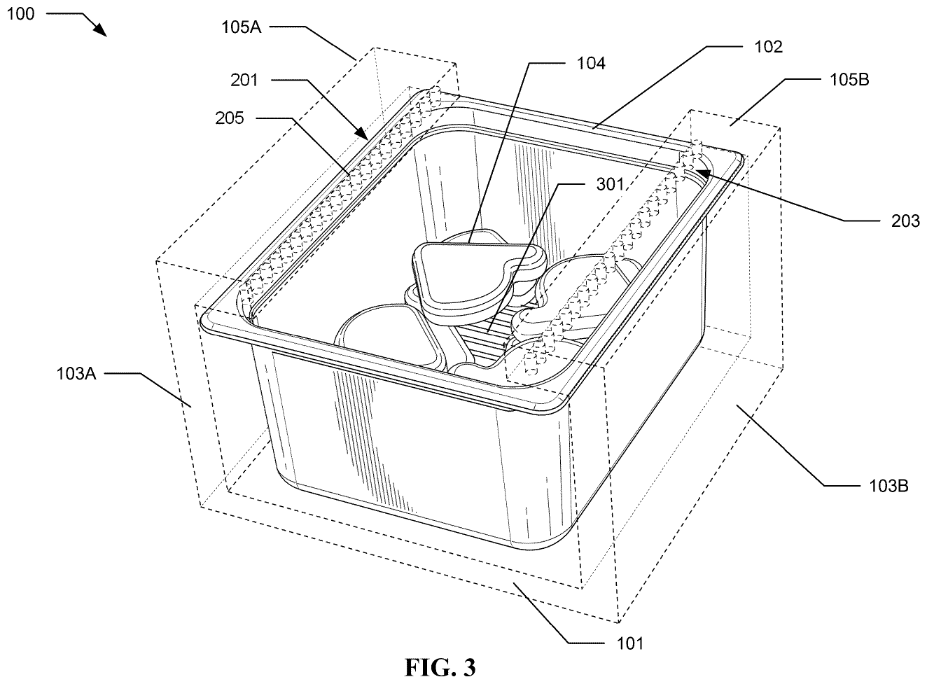

FIG. 3 shows another perspective view of the food holding system 100 and food container 102. In some embodiments, the food container 102 comprises a trivet 301 that provides a raised platform for receiving the plurality of food products 104. In doing so, the trivet 301 may enable airflow circulation pathways beneath the food products 104. For example, the trivet 301 may provide an offset of empty space between the food products 104 and the bottom surface of the food container. In various embodiments, the trivet 301 comprises a wire-formative construction that provides structural support while maintaining open spaces that facilitate heated airflow movement throughout the food container 102 volume. For example, the trivet 301 may include intersecting wire elements that create a grid pattern with multiple apertures, enabling heated air from the first airflow mechanism 201 and the second airflow mechanism 203 to penetrate beneath the food products 104. As another example, the wire-formative design may comprise varying aperture sizes that accommodate different food product configurations while maintaining consistent support characteristics across the trivet 301 surface area.

In some embodiments, the trivet 301 establishes an offset between the wire support structure and the bottom surface of the food container 102, creating a circulation chamber that enables the first heated airflow and the second heated airflow to circulate beneath the plurality of food products 104. In various embodiments, the offset dimension is configured to promote uniform heat distribution while preventing stagnation zones that may result in temperature variations across different areas of the food container 102. For example, the offset may maintain a predetermined distance that accommodates the volume of heated air delivered by the nozzle 205 and associated discharge points while ensuring adequate circulation velocity beneath the food products 104. As another example, the offset spacing may comprise adjustable characteristics that enable modification based on food product thickness or density variations that affect airflow resistance through the food container 102. For example, the trivet 301 may be vertically repositionable to increase or decrease the offset.

In some embodiments, the wire-formative structure of the trivet 301 creates minimal contact points with the food products 104, reducing heat transfer barriers while maintaining stable support for items of varying sizes and shapes. In various embodiments, the open construction of the trivet 301 eliminates solid surfaces that may block airflow circulation or create thermal shadows beneath the food products 104. For example, the wire spacing within the trivet 301 may accommodate the passage of heated air while preventing smaller food products from falling through the support structure. As another example, the trivet 301 may comprise reinforcement elements that maintain structural integrity under loaded conditions while preserving the open characteristics that facilitate airflow circulation.

Alternatively, in some embodiments, the food container 102 comprises or embodies a wire basket that receives the plurality of food products 104. In various embodiments, the wire basket comprises similar wire-formative construction characteristics as the trivet 301, providing additional food product support while directing heated airflow through specific circulation patterns (e.g., underneath and through a volume of food products 104).

In various embodiments, the trivet 301, wire basket, and/or the like, comprise slotted construction features that enable heated air to move through the support structure while maintaining the structural integrity needed to support loaded food. In some embodiments, the slotted design provides directional airflow channels that guide heated air upward from the inferior circulation region through the food products 104 in controlled patterns. In various embodiments, the slot orientation and spacing within the trivet 301 or wire basket correspond to the discharge characteristics of the first airflow mechanism 201 and the second airflow mechanism 203, creating coordinated airflow distribution that maximizes thermal efficiency. For example, the trivet 301 slots may align with the nozzle 205 positions to create direct airflow pathways that minimize pressure losses while maintaining circulation velocity through the food products 104. As another example, the slotted configuration may comprise variable aperture sizes that accommodate different airflow volumes based on the heating requirements of specific food product types or quantities.

In some embodiments, the food holding system 100 comprises per-product control adjustments that modify the operation of the first airflow mechanism 201 and the second airflow mechanism 203 based on the characteristics of different breading products or food types positioned within the wire basket and supported by the trivet 301. In various embodiments, the per-product control system recognizes that different food products require specific thermal treatment parameters to maintain quality characteristics, moving beyond universal on/off settings to provide customized heating profiles. For example, heavily breaded food products may require increased airflow velocity through the trivet 301 and wire basket configuration to penetrate the breading layers, while lightly breaded items may require gentler airflow patterns to prevent surface drying. As another example, the per-product control adjustments may modify the nozzle 205 discharge angles and airflow distribution patterns to accommodate the specific thermal requirements of different food categories while utilizing the same trivet 301 and wire basket support infrastructure.

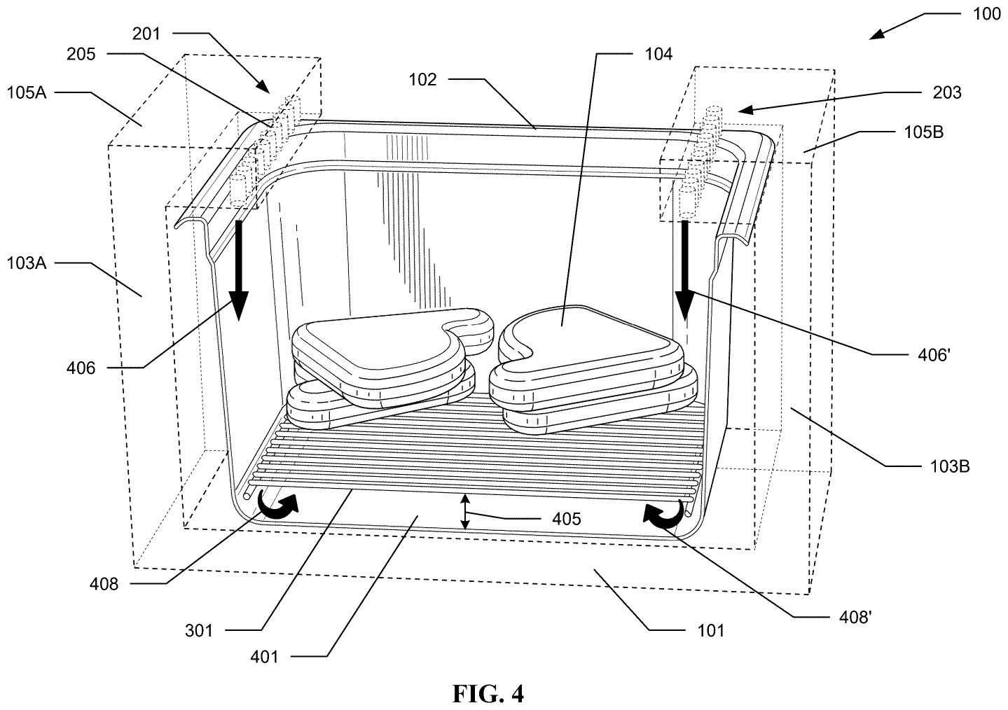

FIG. 4 depicts a cross section 400 of the food holding system 100 and food container 102. As shown, the food holding system 100 demonstrates comprehensive cross-sectional airflow dynamics that illustrate the complete circulation pathways within the food container 102 through coordinated interaction between the first airflow mechanism 201 and the second airflow mechanism 203. In some embodiments, a bottom surface 401 of the food container 102 establishes the foundational boundary for circulation chamber formation beneath the trivet 301. In various embodiments, the bottom surface 401 comprises structural features that facilitate airflow distribution while maintaining the dimensional stability needed to support the trivet 301 and food products 104 under operational loading conditions. For example, the bottom surface 401 may comprise surface textures or channel formations that guide heated airflow from the circulation chamber toward specific areas beneath the trivet 301. As another example, the bottom surface 401 may include thermal conduction properties that complement the heated airflow circulation by providing supplemental heat transfer to the food products 104 through the trivet 301 support structure.

As shown, the trivet 301 provides an offset 405 from the bottom surface 401. In doing so, the trivet 301 may define a circulation chamber that enables airflow movement beneath the food products 104. In various embodiments, the offset 405 dimensions correspond to volumetric targets for the heated airflow delivered by the first airflow mechanism 201 and the second airflow mechanism 203. For example, the offset 405 may maintain a predetermined height that accommodates the pressure and velocity characteristics of heated airflow while preventing stagnation zones that reduce circulation efficiency. As another example, the offset 405 spacing may comprise adjustable features that enable modification based on food product density variations or airflow volume changes that affect circulation patterns within the food container 102. For example, the offset 405 may be increased or decreased via manipulation of the vertical position of the trivet 301.

In various embodiments, the first airflow mechanism 201 and the second airflow mechanism 203 direct heated airflows in downward airflow directions 406, 406′. In doing so, a first heated airflow may be directed toward the interior surface on a first side of the food container 102, and a second heated airflow may be directed toward the interior surface on a second side of the food container 102. In various embodiments, the airflow directions 406, 406′ provide a driving force for the complete circulation pattern by directing heated air downward along the interior surfaces of the food container 102 before the air transitions to horizontal movement within the offset 405 circulation chamber, followed by upward movement through the volume of food products 104. The heated airflows may comprise angular characteristics that optimize penetration through the food products 104 while maintaining sufficient velocity to reach the bottom surface 401.

In various embodiments, the airflow direction 406′ mirrors the circulation characteristics of the airflow direction 406 while originating from the second airflow mechanism 203 to create symmetrical heating conditions across the food container 102. In some embodiments, the airflow direction 406′ establishes balanced circulation patterns that eliminate preferential heating zones regardless of the food container 102 insertion direction within the food holding system 100. For example, the airflow direction 406′ may maintain identical velocity and temperature characteristics as the airflow direction 406 to ensure uniform thermal treatment of food products 104 positioned throughout the food container 102. As another example, the symmetrical configuration of the airflow direction 406 and airflow direction 406′ may enable the food container 102 to slide from either end of the food holding system 100 while maintaining consistent circulation patterns that promote even heating through the bidirectional insertion capability.

In various embodiments, an airflow direction 408 illustrates the redirection and upward return flow component that carries heated air through spaces between the food products 104 after circulation through the offset 405 beneath the trivet 301. In some embodiments, the airflow direction 408 completes the circulation pattern by transporting thermal energy from the circulation chamber upward through the food product mass to maintain temperature uniformity throughout the food container 102 volume. In some embodiments, the airflow direction 408 generates convective currents that continuously expose all surfaces of the food products 104 to heated air movement, preventing thermal stratification or localized cooling effects. For example, the airflow direction 408 may comprise laminar flow characteristics that enhance heat transfer coefficients around individual food products 104 while maintaining sufficient velocity to prevent air stagnation between items.

In some embodiments, a second airflow direction 408′ illustrates, on an opposite side of the food container 102, the corresponding upward return flow of the second heated airflow. The first and second airflow directions may provide balanced circulation that work in coordination to establish comprehensive thermal coverage. In various embodiments, the airflow direction 408′ maintains symmetrical flow characteristics that complement the airflow direction 408 while ensuring that heated air circulation reaches all areas of the food container 102 regardless of food product positioning or density variations. For example, the airflow direction 408′ may comprise identical flow velocity and temperature parameters as the airflow direction 408 to maintain uniform circulation patterns across the entire food container 102 volume. As another example, the coordination between the airflow direction 408 and airflow direction 408′ may create overlapping circulation zones that eliminate dead spaces where heated air movement becomes insufficient to maintain temperature requirements for the food products 104.

As further shown in FIG. 4, the complete circulation pattern comprising the airflow direction 406, airflow direction 406′, airflow direction 408, and airflow direction 408′ demonstrates the coordinated interaction between downward flow along interior surfaces of the food container 102 and upward return flow through the volume of the food products 104. The circulation pattern may allow a hold time of about 30 minutes during which the held food product does not depreciate materially in quality, while still allowing team members to access the food product quickly, such as might happen during a lunch rush. While a full container of food products may be depleted over a 30 minute period, the last food product item remaining at the bottom of the container may not be noticeably different in quality than the first food product item removed from the top of the container. This is a significant improvement over prior art for open holding containers or pans.

In some embodiments, the circulation pattern is adjustable based on one or more variables including temperature, velocity, vertical position of the lips 105A, 105B, horizontal position of the lips 105A, 105B, vertical dimension of the offset 405, and/or the like. In various embodiments, the circulation pattern creates continuous air movement that prevents thermal boundary layer formation around individual food products 104 while maintaining consistent temperature distribution throughout the food container 102. For example, the circulation pattern may comprise pressure differentials that drive heated air through the offset 405 chamber with sufficient velocity to penetrate upward through dense food product arrangements. As another example, the circulation pattern may respond to humidity control element adjustments that modify air moisture content to optimize food product quality during extended hold periods.

In various embodiments, one or more humidity control mechanisms integrate with the circulation pattern to adjust moisture content of air directed from the airflow mechanisms 201, 203 and associated discharge points, extending hold time for the food products 104 by preventing quality degradation associated with excessive dehydration or moisture accumulation. In some embodiments, the humidity control elements operate within the airflow direction 406 and airflow direction 406′ pathways to condition heated air before the air enters the food container 102 circulation system. For example, the humidity control mechanisms may comprise moisture control systems that remove excess moisture from recirculated air to prevent condensation accumulation that affects food product texture or presentation quality.

In some embodiments, one or more air intake systems within the first lip 105A, the second lip 105B, the first sidewall 103A, the second sidewall 103B, and/or the like capture return flows to facilitate recirculation through the first airflow mechanism 201 and the second airflow mechanism 203. In various embodiments, the air intake systems comprise moisture scrubbing capabilities that remove accumulated humidity from recirculated air before returning the air to heating elements positioned below the food holding system 100 structure. For example, the air intake systems may include condensation removal components that extract moisture content from the heated airflow return streams to maintain optimal humidity levels within the circulation pattern. As another example, the moisture scrubbing capabilities may comprise filtration elements that remove food particles or contaminants from recirculated air while preserving the thermal energy content for reuse in the circulation system.

In various embodiments, heating and fan mechanisms positioned inferior to the bottom surface 101 provide heated air to the first airflow mechanism 201 and the second airflow mechanism 203 through supply conduits that connect to the airflow direction 406 and airflow direction 406′ delivery pathways. In some embodiments, the inferior positioning of heating and fan mechanisms creates space efficiency advantages by locating heat generation and air movement components below the table structure rather than within the first sidewall 103A and second sidewall 103B assemblies. In various embodiments, the below-table positioning enables multiple food holding systems 100 to share common heating infrastructure while maintaining independent circulation control for each food container 102. For example, multiple food holding system structures 100 may be stacked on top of one another, to provide operational flexibility or increased holding capacity, and may be supplied with heated air supplied by the common heating infrastructure. The heating and fan mechanisms may comprise variable speed capabilities that enable adjustment of airflow rates based on food product loading or the number of food holding systems 100 being supplied. As another example, the inferior positioning may facilitate maintenance access to heating and fan components without disrupting food service operations or requiring removal of the food container 102 from the food holding system 100.

The heating infrastructure, according to embodiments, be located in the ceiling of a cabinet structure that extends over the lips 105 A, B such that the heated air is blown downwardly to the lips, and then to the food container 102. A cabinet structure suitable for such embodiments is described in PCT application PCT/US2024/044606, which is hereby incorporated by reference in its entirety.

In various embodiments, the bidirectional sliding capability of the food container 102 within the food holding system 100 promotes symmetrical heating patterns through the coordinated operation of the airflow direction 406, airflow direction 406′, airflow direction 408, and airflow direction 408′ circulation components. In some embodiments, the symmetrical configuration eliminates preferential heating zones that result from asymmetrical airflow distribution, enabling consistent thermal treatment regardless of the food container 102 insertion direction. For example, the bidirectional sliding feature may enable food service operations to position the food container 102 from either end of the food holding system 100 while maintaining identical circulation patterns through the offset 405 chamber and trivet 301 support structure. As another example, the symmetrical heating capability may compensate for natural heat loss patterns that occur at food container 102 edges by providing balanced airflow distribution that maintains temperature uniformity across all food products 104 regardless of positioning within the circulation system.

In some embodiments, one or more sensor systems detect insertion of the food container 102 onto the bottom surface 101. In response to the detection, the first airflow mechanism 201 and the second airflow mechanism 203 may be activated to initiate temperature maintenance operations. In various embodiments, computing devices connected to the sensor systems control the activation sequence and operational parameters of the circulation system based on food container 102 positioning and loading characteristics. For example, the sensor systems may detect the weight or thermal characteristics of food products 104 within the food container 102 and adjust the airflow rates delivered through the airflow direction 406 and airflow direction 406′ pathways to optimize circulation effectiveness. As another example, the computing devices may comprise learning algorithms that modify circulation parameters based on historical performance data for specific food product types or container configurations, optimizing the variables of the temperature maintenance operations, such as airflow velocity, airflow temperature, offset dimensions, vertical and/or horizontal position of the lips 105A, 105B, and/or the like. For example, the food holding system 100 may increase airflow velocity through in response to detecting higher food product densities that require enhanced circulation to maintain temperature uniformity.

In various embodiments, the food holding system comprises adjustable positioning capabilities that enable modification of the respective position of the first lip 105A and the second lip 105B to accommodate different food container configurations and operational requirements. In various embodiments, the first lip 105A and second lip 105B are vertically repositionable along the first sidewall and second sidewall, respectively, enabling adjustment of the vertical clearance between the airflow discharge points and the food products positioned within the food container. For example, the vertical repositioning capability may enable operators to increase the clearance distance when working with taller food products that require additional space for proper airflow circulation patterns. As another example, the vertical adjustment feature may allow positioning of the first lip 105A and second lip 105B closer to the food container to reduce the vertical profile of the food holding system 100 and/or to configure the food holding system for operation with lower-profile food products that benefit from more direct heated airflow exposure.

In various embodiments, the first lip 105A and second lip 105B are horizontally repositionable to increase or decrease a span of the gap between the airflow mechanisms, enabling customization of the access opening dimensions based on food container sizes and service requirements. In some embodiments, the horizontal repositioning capability accommodates food containers of varying widths while maintaining optimal airflow distribution patterns across the food products. For example, the horizontal adjustment feature may enable expansion of the gap span to accommodate wider food containers that require increased access clearance for food retrieval operations. As another example, the horizontal repositioning capability may allow reduction of the gap span when working with narrower food containers to concentrate heated airflow distribution and improve thermal efficiency. In this manner, the food holding system 100 may adjust the span of between the first lip 105A and the second lip 105B to calibrate the outlet of the heated airflows to the bounds of the food container 102.

In various embodiments, the combination of vertical and horizontal repositioning capabilities creates a comprehensive adjustment system that enables optimization of airflow patterns for specific food product characteristics and container configurations. In some embodiments, the dual-axis adjustment capability enables operators to establish custom clearance dimensions that balance accessibility requirements with thermal efficiency considerations for different food service applications. For example, the combined adjustment capability may enable positioning of the first lip 105A and second lip 105B to create optimal airflow angles for specific food product heights while maintaining appropriate gap dimensions for team member access. As another example, the comprehensive positioning system may accommodate seasonal menu changes or special food products that require non-standard heating configurations without modification of the underlying heating infrastructure.

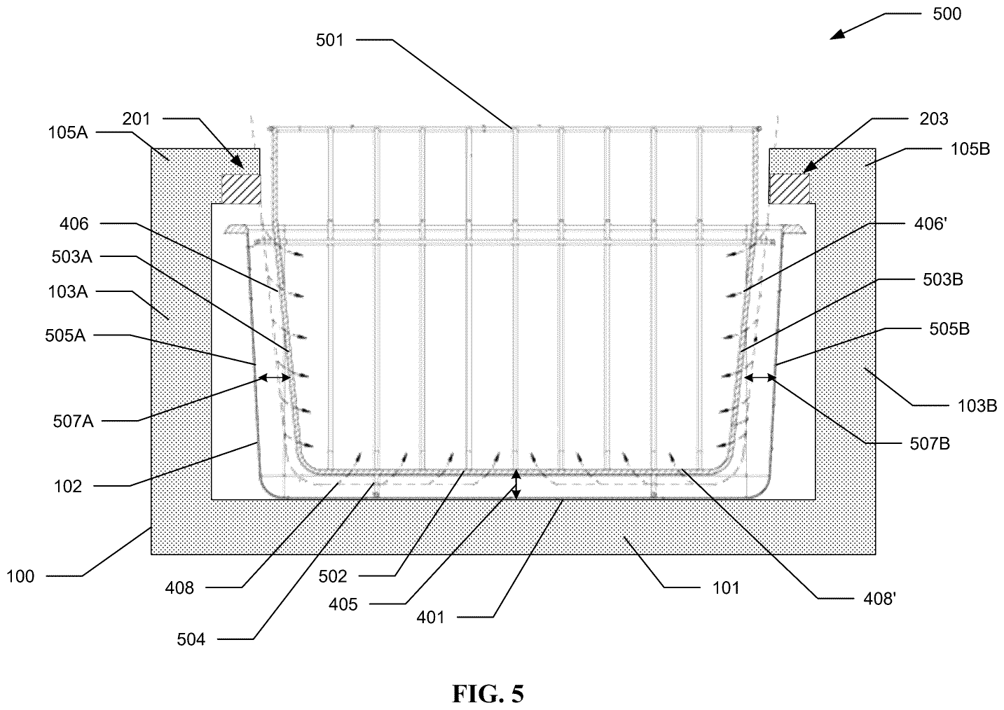

FIG. 5 shows a cross section 500 of a food holding system 100, a food container 102, and a food holder 501. In various embodiments, the food container 102 is configured to receive the food holder 501. The food holder 501 may comprise a plurality of food products, such as fillets, nuggets, tenders, fries, and/or the like. In various embodiments, the food holder is permeable to heated airflows emitted from the first airflow mechanism 201 and the second airflow mechanism 203. For example, the food holder 501 may embody or comprise a wire basket through which heated air may pass to contact and warm food products held therewithin. In various embodiments, the food holder 501 provides an offset 405 from a bottom surface 401 of the food container 102. For example, a bottom surface 502 may be vertically offset from the bottom surface 401. In this manner, heated airflows may circulate beneath the volume of food products (e.g., in airflow directions 408, 408′) and penetrate upward through the food holder 501, which may improve thermal efficiency and uniformity of warming processes.

In various embodiments, the food holder 501 comprises sidewalls, one or more of which may be permeable to heated airflows. For example, the food holder 501 may comprise a first sidewall 503A and a second sidewall 503B, which may be wireframes permitting airflow passage. In various embodiments, the first sidewall 503A and the second sidewall 503B are horizontally offset relative to the corresponding sidewalls of the food container 102. For example, a horizontal offset 507A may be present between the first sidewall 503A of the food holder 501 and a first sidewall 505A of the food container 102, and a horizontal offset 507B may be present between the second sidewall 503B and a second sidewall 505B of the food container 102. The horizontal offsets may define void spaces extending downward along the height of the food holder 501, enabling airflows to pass directly downward between the sidewalls 503A, 505B of the food holder 501 and the sidewalls 505A, 505B of the food container 102 (e.g., as indicated by airflow directions 406, 406′).

As shown, the downward directed airflows may pass directly into the void space defined by the vertical offset 405 to circulate beneath the bottom surface 502 of the food holder 501. Additionally, in some embodiments, the horizontal offsets 507A, 507B enable portions of the heated airflows to pass into the food holder 501 at varying heights along the length of the sidewalls 503A, 503B, which may increase heating uniformity by enabling the heated airflows to penetrate the volume of food products at multiple vertical levels. In various embodiments, the horizontal offset 507A, 507B overcome limitations commonly encountered with conventional heat lamp systems, where food products positioned at lower levels within containers may receive insufficient thermal exposure. The bottom-first heating aspects and/or multi-vertical level heating aspects may reduce the likelihood of surface overheating that commonly occurs with direct overhead radiant heating, while ensuring that lower portions of food products 104 receive adequate thermal treatment to maintain serving temperature requirements.

In various embodiments, the repositioning capabilities enable accommodation of future food product innovations or menu expansions that utilize different heating configurations without replacement of the food holding system infrastructure. In some embodiments, the adjustment flexibility supports operational adaptability by enabling modification of airflow patterns and clearance dimensions as food service requirements evolve over time. For example, the repositioning systems may accommodate introduction of new food product categories that require specific thermal treatment parameters while utilizing existing heating and airflow generation components. As another example, the adjustment capabilities may enable seasonal configuration changes that optimize heating performance for different food product mixes without disruption of established food service workflows.

While various aspects have been described, additional aspects, features, and methodologies of the claimed apparatuses will be readily discernible from the description herein, by those of ordinary skill in the art. Many embodiments and adaptations of the disclosure and claimed inventions other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed inventions. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed inventions. In addition, some steps may be carried out simultaneously, contemporaneously, or in synchronization with other steps.

The embodiments were chosen and described in order to explain the principles of the claimed inventions and their practical application so as to enable others skilled in the art to utilize the inventions and various embodiments and with various modifications as are suited to the particular use contemplated. Alternative embodiments will become apparent to those skilled in the art to which the claimed inventions pertain without departing from their spirit and scope. Accordingly, the scope of the claimed inventions is defined by the appended claims rather than the foregoing description and the exemplary embodiments described therein.

1. A food holding system, comprising:
a bottom surface configured to receive a food container comprising a plurality of food products;
a first sidewall extending upward from a first edge of the bottom surface and comprising a first lip extending over at least a first portion of the bottom surface;
a second sidewall extending upward from a second edge of the bottom surface and comprising a second lip extending over at least a second portion of the bottom surface;
the first lip and the second lip defining a gap between one another;
the gap configured to provide access to the plurality of food products within the food container;
the first lip comprising a first airflow mechanism configured to direct a first heated airflow directed into the food container;
the second lip comprising a second airflow mechanism configured to direct a second heated airflow directed into the food container; and
the first heated airflow and the second heated airflow configured to maintain the plurality of food products within a predetermined temperature range.

2. The food holding system of claim 1, further comprising:
a void extending between the first sidewall and the second sidewall; and
the void enabling bidirectional insertion of the food container into the food holding system.

3. The food holding system of claim 1, wherein:
the first airflow mechanism and the second airflow mechanism comprise, respectively, a plurality of nozzles extending along at least a subset of the first lip or the second lip.

4. The food holding system of claim 3, wherein:
the plurality of nozzles comprises at least one row of nozzles.

5. The food holding system of claim 1, wherein:
the first airflow mechanism and the second airflow mechanism comprise, respectively, a slot extending along at least a portion of the first lip or the second lip.

6. The food holding system of claim 1, wherein:
the food container comprises a food pan; and
the food pan comprises:
a bottom surface;
a food holder configured to support the plurality of food products; and
an offset between the food holder and the bottom surface, the offset configured to allow the first heated airflow and the second heated airflow to circulate beneath the plurality of food products.

7. The food holding system of claim 6, wherein:
the food holder embodies a wire trivet.

8. The food holding system of claim 6, wherein:
the food holding system embodies a wire basket.

9. The food holding system of claim 8, wherein:
the wire basket comprises a plurality of sidewalls; and
at least a subset of the plurality of sidewalls are offset relative to corresponding sidewalls of the food container.

10. The food holding system of claim 1, wherein:
the food holding system is unenclosed.

11. The food holding system of claim 1, further comprising:
at least one blower positioned inferior to the bottom surface and configured to provide the first heated airflow to the first airflow mechanism and the second heated airflow to the second airflow mechanism.

12. The food holding system of claim 1, wherein:
the first heated airflow and the second heated airflow are configured to create a circulation pattern comprising a downward flow along interior surfaces of the food container and an upward return flow through spaces between the plurality of food products.

13. The food holding system of claim 1, wherein:
at least one of the bottom surface, the first sidewall, or the second sidewall comprises at least one heating mechanism configured to generate at least one the first heated airflow or the second heated airflow.

14. A food holding system, comprising:
a bottom surface;
a food pan positioned on the bottom surface and comprising a plurality of food products;
a first lip extending over a first side of the food pan;
a second lip extending over a second side of the food pan;
the first lip and the second lip spaced apart from one another to define a gap providing access to the plurality of food products; and
the first lip and the second lip each comprising an airflow mechanism configured to direct a heated airflow through the plurality of food products.

15. The food holding system of claim 14, further comprising:
at least one humidity control mechanism configured to control a respective moisture level of the heated airflow.

16. The food holding system of claim 14, further comprising:
at least one air intake within at least one of the first lip or the second lip; and
the at least one air intake configured to receive the heated airflow for recirculation through the airflow mechanism.

17. The food holding system of claim 14, further comprising:
at least one heating element positioned inferior to the bottom surface and configured to provide heated air to the airflow mechanism.

18. The food holding system of claim 14, wherein:
a length of the bottom surface is equal to a length of the food pan.

19. The food holding system of claim 14, further comprising:
at least one blower configured to generate the heated airflow, wherein the at least one blower is positioned inferior to the bottom surface.

20. A method of holding warmed food products, comprising:
receiving a food container onto a bottom surface of a food holding system to position a first side of the food container under a first lip of the food holding system and a second side of the food container under a second lip of the food holding system;
exposing a plurality of food products for retrieval from the food container through a gap between the first lip and the second lip;
directing, via an airflow mechanism of the first lip, a first heated airflow into the first side of the food container; and
directing, via an airflow mechanism of the second lip, a second heated airflow into the second side of the food container, wherein:
the food container comprises a plurality of food products held at an offset above a bottom surface of the food container.
